(19) United States
(12) Patent Application Publication
(10) Pub. No.: US 2021/0208752 A1
(43) Pub. Date: Jul. 8, 2021

(54) APPARATUS AND METHOD FOR DISPLAYING CHATROOM ASSOCIATED WITH MESSENGER APPLICATION

(71) Applicant: LINE Plus Corporation, Seongnam-si (KR)

(72) Inventor: Yonggi HWANG, Seongnam-si (KR)

(73) Assignee: LINE Plus Corporation, Seongnam-si (KR)

(21) Appl. No.: 17/210,027

(22) Filed: Mar. 23, 2021

Related U.S. Application Data
(63) Continuation of application No. PCT/KR2018/011378, filed on Sep. 27, 2018.

(51) Int. Cl. G06F 3/0483; G06F 3/0486; H04L 12/58; G06Q 50/00; G06F 16/28

(52) U.S. Cl. CPC G06F 3/0483; G06F 3/0486; G06F 3/0488; G06Q 50/01; G06F 16/287; H04L 51/22

(57) ABSTRACT

A method of displaying a chatroom on a messenger application may include: creating a tab associated with a chatroom group in response to a user input to a user terminal; automatically classifying the chatroom into the chatroom group based on a chatroom attribute or classifying the chatroom into the chatroom group in response to detecting a drag-and-drop manipulation of dragging the chatroom to the tab; and displaying a chatroom list of a plurality of chatrooms that belong to the chatroom group in response to a selection of the tab.

### CROSS-REFERENCE TO RELATED APPLICATION

This application is a continuation application of International Application No. PCT/KR2018/011378 filed on Sep. 27, 2018, the disclosure of which is incorporated herein by reference in its entirety.

### BACKGROUND

### 1. Field

Example embodiments of the following description relate to a method of displaying a chatroom associated with a messenger application, and more particularly, to a method of classifying a chatroom into a chatroom group associated with each tab and displaying the chatroom using at least one tab included in a tab user interface.

### 2. Description of Related Art

A messenger application is widely used in exchanging messages or contents between users. The messenger application is installed on a mobile terminal or a personal computer (PC) of a user and enables the user to exchange a message with another user or to send content to the other user.

The user of the messenger application manages chat with another user (or other users) through a chatroom. That is, the user and the other user may exchange messages and contents in the chatroom.

In the case of using the messenger application, a plurality of chatrooms may be present in the messenger application. In this case, the user may not readily chat with another user or exchange content with the other user through an appropriate selection of a desired chatroom. That is, since a plurality of chatrooms are sorted in order in which a latest incoming message is present, the user may not readily select a chatroom associated with another user to chat with after a long time. Also, although the user does not desire to view chat content (even at least a portion of) of a specific chatroom, the user may have no choice but to view the chat content undesired to view to select the specific chatroom.

Accordingly, there is a need for a chatroom management method that may further intuitively classify and display a chatroom associated with a messenger application such that a user may easily select a desired chatroom.

### SUMMARY

One or more example embodiments may provide a method for creating a tab or a tab user interface associated with a chatroom group, automatically classifying a chatroom into a chatroom group associated with a tab based on a condition according to a chatroom attribute, and displaying a list of chatrooms included in the chatroom group associated with a selected tab.

One or more example embodiments may provide a method for creating a tab or a tab user interface associated with a chatroom group, classifying a chatroom into a chatroom group associated with a tab in response to detecting a drag-and-drop manipulation to the tab for the chatroom, and displaying a list of chatrooms included in a chatroom group associated with a selected tab.

One or more example embodiments may provide a method for setting a group setting value for each tab with respect to a plurality of chatrooms classified in association with a tab and collectively applying the set group setting value to chatrooms belonging to a chatroom group.

According to an aspect of the present disclosure, there is provided a method of displaying a first chatroom through a tab user interface of a messenger application executed by a user terminal. The method may include: creating a first tab associated with a first chatroom group in response to an input from a first user of the user terminal; automatically classifying the first chatroom into the first chatroom group based on a chatroom attribute or classifying the first chatroom into the first chatroom group in response to detecting a first drag-and-drop manipulation of dragging the first chatroom to the first tab and then dropping the first chatroom into the first tab; and displaying a chatroom list of a plurality of chatrooms that belong to the first chatroom group in response to a selection of the first tab.

The chatroom attribute may include at least one of chat content included in the first chatroom, information associated with a participant of the first chatroom, information associated with a second chatroom in which the participant of the first chatroom participates, and position information associated with the first chatroom.

The chatroom attribute may include the chat content included in the first chatroom, and the automatically classifying the first chatroom may include: automatically classifying the first chatroom into the first chatroom group based on a first condition, a second condition, or a third condition. The first condition may be satisfied when a preset word occurs a first preset number of times or more in the first chatroom, or occurs at or higher than a first preset ratio corresponding to a number of occurrences of the preset word to a number of messages in the first chatroom. The second condition may be satisfied when a formal expression or an informal expression occurs a second preset number of times or more in the first chatroom, or occurs at or higher than a second preset ratio corresponding to a number of occurrences of the formal expression or the informal expression to the number of messages in the first chatroom. The third condition may be satisfied when an emoticon or a sticker occurs a third preset number of times or more in the first chatroom, or occurs at or higher than a third preset ratio corresponding to a number of occurrences of the emoticon or the sticker in the first chatroom. The method may further include: classifying the second chatroom which satisfies a same condition as the first chatroom into the first chatroom group, among the first condition, the second condition, and the third condition.

The chatroom attribute may include the information associated with the participant of the first chatroom. The automatically classifying the first chatroom may include: automatically classifying the first chatroom into the first chatroom group according to a condition that is set based on at least one of profile information of the participant, position information of the participant, and contact information associated with the participant that is stored in the user terminal. The method may further include automatically classifying the second chatroom, which satisfies the same condition as the first chatroom, into the first chatroom group.

The chatroom attribute may include the information associated with the second chatroom in which the participant of the first chatroom participates. The first chatroom may be a personal chatroom for two participants including the first user and a second user, and the second chatroom may be a group chatroom for at least three participants including the first user and the second user. The automatically classifying the first chatroom may include automatically classifying the first chatroom into the first chatroom group into which the group chatroom is classified in response to the group chatroom being classified in advance, or automatically classifying the first chatroom into a second chatroom group related to an identified conversation topic of the group chatroom.

A name of the first chatroom group may be determined based on a name of the group chatroom or the identified conversation topic of the group chatroom.

The chatroom attribute may include the position information associated with the first chatroom. The automatically classifying the first chatroom may include: automatically classifying the first chatroom into the first chatroom group according to a condition that is set based on a first position of the user terminal at a time of creating the first chatroom or a second position of the first user that creates the first chatroom at the time of creating the first chatroom. The method may further include automatically classifying the second chatroom, which satisfies the same condition as the first chatroom, into the first chatroom group.

The tab user interface may include a plurality of tabs. The method may further include reclassifying the first chatroom into a second chatroom group associated with a second tab in response to detecting a second drag-and-drop manipulation of dragging the first chatroom to the second tab, among the plurality of tabs.

The method may further include: setting a group setting value of the first chatroom group associated with the first tab; and applying the group setting value to the plurality of chatrooms belonging to the first chatroom group.

The group setting value may include at least one of a notification setting according to reception of a new message, a message processing setting, and a chatroom theme setting, as the group setting value that is collectively applied to the plurality of chatrooms belonging to the first chatroom group.

The group setting value may include the notification setting, to turn off or on a notification according to the reception of the new message or to output the notification at a preset time interval in response to receiving the new message.

The group setting value may include the message processing setting, and the message processing setting may include collectively sending messages to the plurality of chatrooms belonging to the first chatroom group or collectively processing unread messages received at the plurality of chatrooms belonging to the first chatroom group as read messages.

The group setting value may include the chatroom theme setting, and the chatroom theme setting may include changing at least one of a background screen setting for all chatrooms belonging to the first chatroom group, a background music setting for all the chatrooms belonging to the first chatroom group, a profile setting of a participant associated with the first chatroom belonging to the first chatroom group, and a profile setting of the first chatroom belonging to the first chatroom group.

The tab user interface may include a user interface of adding a second tab or deleting the first tab. The first tab may display a name of the first tab, a number of chatrooms in which a new message is received among the plurality of chatrooms in the first chatroom group associated with the first tab, or a number of new messages in the plurality of chatrooms in the first chatroom group associated with the first tab.

The tab user interface may include a plurality of tabs, and positions of the plurality of tabs may vary based on a third drag-and-drop manipulation on the plurality of tabs.

According to another aspect of the present disclosure, there is provided a non-transitory computer-readable record medium storing instructions that, when executed by a processor of the user terminal, cause the processor to perform the method of displaying the first chatroom.

According to another aspect of the present disclosure, there is provided an electronic device for displaying a chatroom through a tab user interface of a messenger application, including: at least one memory configured to store one or more instructions; and at least one processor configured to execute the one or more instructions to: create a tab associated with a chatroom group in response to an input from a user of the electronic device; automatically classify the chatroom into the chatroom group based on a chatroom attribute or classify the chatroom into the chatroom group in response to detecting a drag-and-drop manipulation of dragging the chatroom to the for the chatroom and then dropping the chatroom into the tab; and display a chatroom list of a plurality of chatrooms that belong to the chatroom group in response to receiving a selection of the tab.

The least one processor may be further configured to execute the one or more instructions to: set a group setting value of the chatroom group associated with the tab and apply the group setting value to the plurality of chatrooms belonging to the chatroom group.

According to another aspect of the present disclosure, there is provided an electronic device for executing a messenger application, including: a display; at least one memory configured to store one or more instructions; and at least one processor configured to execute the one or more instructions to: control the display to display, on the messenger application, a plurality of tabs corresponding to a plurality of different chatroom groups, respectively; automatically classify a new message into a first chatroom group based on an attribute of the new message, among the plurality of different chatroom groups; and automatically place the new message in a first tab corresponding to the first chatroom group, among the plurality of tabs on the messenger application.

The attribute of the new message may include occurrence of a preset word in the new message.

### BRIEF DESCRIPTION OF THE DRAWINGS

The above and/or other aspects will be more apparent by describing certain example embodiments, with reference to the accompanying drawings, in which:

FIG. 1 illustrates an example of a method of managing a chatroom associated with a messenger application using a tab included in a tab user interface according to at least one example embodiment;

FIG. 2 illustrates an example of components of an electronic device for managing a chatroom according to at least one example embodiment;

FIG. 3 is a flowchart illustrating an example of a method of managing a chatroom associated with a messenger application using a tab included in a tab user interface according to at least one example embodiment;

FIG. 4 is a flowchart illustrating an example of setting a group setting value for a chatroom group including a chatroom for each tab and applying the group setting value to chatrooms belonging to the chatroom group according to at least one example embodiment;

FIG. 5 illustrates an example of a method of classifying a chatroom into a chatroom group associated with a tab and a tab manipulation method according to at least one example embodiment;

FIG. 6 illustrates an example of a method of automatically classifying a chatroom into a predetermined (or, alternatively, desired) chatroom group based on chat content included in the chatroom according to at least one example embodiment;

FIG. 7 illustrates an example of a method of automatically classifying a chatroom into a predetermined (or, alternatively, desired) chatroom group based on information associated with another chatroom in which a participant of the chatroom participates according to at least one example embodiment;

FIG. 8 illustrates an example of a method of setting a group setting value for a chatroom group associated with a tab and collectively applying the set group setting value to chatrooms belonging to the chatroom group according to at least one example embodiment; and

FIG. 9 illustrates an example of a method of changing a chatroom theme setting using a group setting value according to at least one example embodiment.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer record medium or device, capable of providing instructions or data to, or being interpreted by, a hardware device. The software also may be distributed over network coupled computer systems so that the software is stored and executed in a distributed fashion. In particular, for example, software and data may be stored by one or more computer readable record mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable record medium into the one or more storage devices and/or one or more computer processing devices using a drive mechanism. Such separate computer readable record medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable record medium. Additionally, the computer programs, program code, instructions, or some combination thereof, may be loaded into the one or more storage devices and/or the one or more processors from a remote computing system that is configured to forward and/or distribute the computer programs, program code, instructions, or some combination thereof, over a network. The remote computing system may forward and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments are described with reference to the accompanying drawings. Like reference numerals refer to like elements.

In the following description, it may be described for clarity of description that a function and/or an operation performed by an electronic device or a user terminal or a configuration included therein may be performed by not the corresponding configuration but an upper configuration or the electronic device or the user terminal including the corresponding configuration.

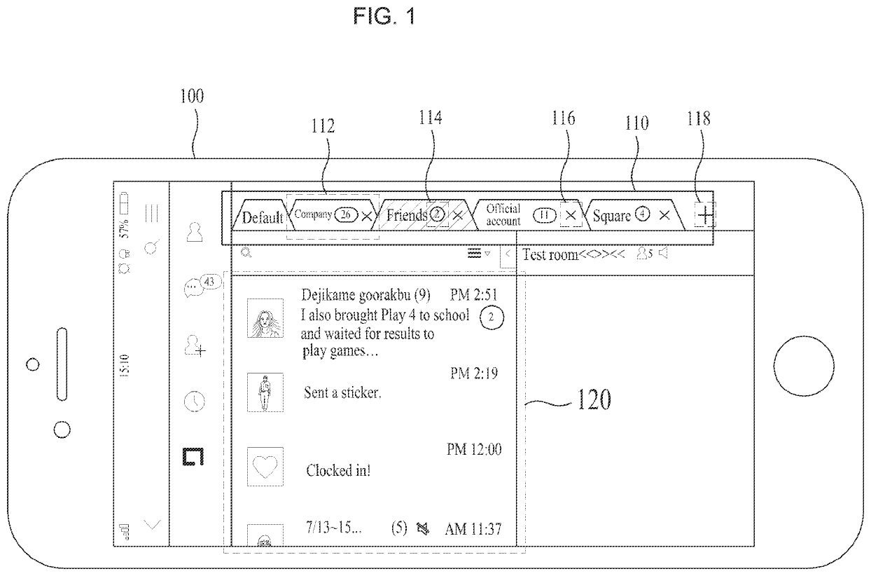

FIG. 1 illustrates an example of a method of managing a chatroom associated with a messenger application using a tab included in a tab user interface according to at least one example embodiment.

FIG. 1 illustrates a screen of an electronic device 100 on which a messenger application is executed. The electronic device 100 may be, for example, a mobile user terminal such as a smartphone and a computing device such as a personal computer (PC).

The messenger application may be a software program or a software application used to exchange messages or contents between users. The messenger application may be installed on the electronic device 100, as a PC version or a mobile version corresponding to a PC or a mobile terminal of a user. That is, the messenger application may be a computer program for the mobile terminal or the PC.

The user of the messenger application may exchange messages with another user or may send content to the other user by executing the messenger application.

The user of the messenger application may manage chat, that is, messages sent and received with other user(s) through the chatroom. That is, the user and the other user corresponding to participants of the chatroom may exchange messages and contents in the chatroom. The sent and received messages and contents may be managed in the chatroom.

A chatroom management method according to the following example embodiment may be provided as a function of the messenger application.

Meanwhile, the chatroom may be provided for chat with at least one user or chatbot. For example, the chatroom may be for a group chatroom in which at least three participants are present or may be an individual or personal chatroom in which two participants are present. Also, the chatroom may be a chatroom (hereinafter, an official account chatroom) associated with an official account for chat with a virtual user such as a chatbot instead of an actual user. The official account refers to an account of an organization or a virtual user for transferring advertising, information, or content. A user who joins the official account chatroom may acquire advertising, information, or content by chatting with the chatbot associated with the official account that transfers the advertising, information, or the content.

Referring to FIG. 1, chatroom(s) associated with the messenger application may be classified into at least one chatroom group through linkage with each corresponding tab included in a tab user interface 110.

For example, the tab user interface 110 may include a plurality of tabs including a tab 112, and each of the plurality of tabs may be associated with a single chatroom group. The chatroom group may be a chatroom group (“Company” group) related to a company or a business, a chatroom group (“Friends” group) related to friends or fellowships, or a chatroom group (“Official account” group) related to an official account chatroom. In FIG. 1, a “Default” group refers to at least one remaining group among chatrooms, such as, for example, a group for displaying a list of unclassified or unclassifiable chatrooms and a chatroom group for displaying a list of the entire chatrooms associated with the messenger application. A “Square” group may be a chatroom group for displaying a list of chatrooms corresponding to a square chatroom among the chatrooms. The square chatroom may be a public or open chatroom that allows a user to chat with participants (not limited to invited members or users of a friend list registered to the messenger application) about a common interest or a topic of conversation.

Referring to FIG. 1, a tab associated with “Friends” group is selected and chatrooms 120 are allocated to the “Friends” group. Here, in response to a selection on the tab associated with the “Friends” group, a list of the chatrooms 120 may be displayed. The chatrooms 120 may be sorted in the order in which the most recent incoming message appears at the top, or a chatroom in which an unread message is present may be displayed at the top.

The tab user interface 110 may include a tab addition user interface 118 for adding a new tab and a user interface 116 for deleting an existing tab. The user of the electronic device 100 may create a new tab associated with a new chatroom group at a leftmost, for example, on the right of a “Square tab” in FIG. 1, by selecting the tab addition user interface 118 and may delete an “Official account” tab by selecting a user interface for deleting an existing tab, for example, the user interface 116. When a tab is selected, chatrooms belonging to a chatroom group associated with the corresponding tab may be declassified from the corresponding chatroom group. Alternatively, although the tab is deleted, chatrooms belonging to the chatroom group associated with the corresponding tab may be maintained to be classified into the corresponding chatroom group. Here, the tab created through the tab addition user interface 118 may be associated with the chatroom group associated with the deleted tab. Through this, the deleted tab may be restored.

Each tab may include a name of the tab and a number of new messages in each chatroom in a chatroom group associated with the tab. For example, a user interface 114 may show that a name of a tab is “Friends” and may also show that there are two new messages in the “Friend” tab. A new message may represent an unread message.

The user interface 114 may represent a number of chatrooms in which a new message is received among chatrooms in the chatroom group associated with the “Friends” tab. Therefore, the example embodiments may be implemented such that “2” of the user interface 114 may represent that a new message(s) is present in two chatrooms.

The name of the tab may represent a name of a chatroom group associated with the tab. The user of the electronic device 100 may change the name of the tab by selecting an area on which the name of the tab is displayed, using, for example, a long touch, a double click, and a right click. The name of the tab may be selected in response to an input from the user when a new tab is created in response to a selection of the tab addition user interface 118. Also, the name of the tab may be automatically set based on information about a chatroom of which a name of an associated chatroom group belongs to the chatroom group.

Depending on example embodiments, a chatroom associated with a messenger application may be classified for purpose of the user by displaying the chatroom to be classified into a chatroom group associated with the tab included in the tab user interface 110. Therefore, the user may easily select a chatroom that is suitable for a user or the user desires to chat with, or may select a chatroom based on a conversation topic.

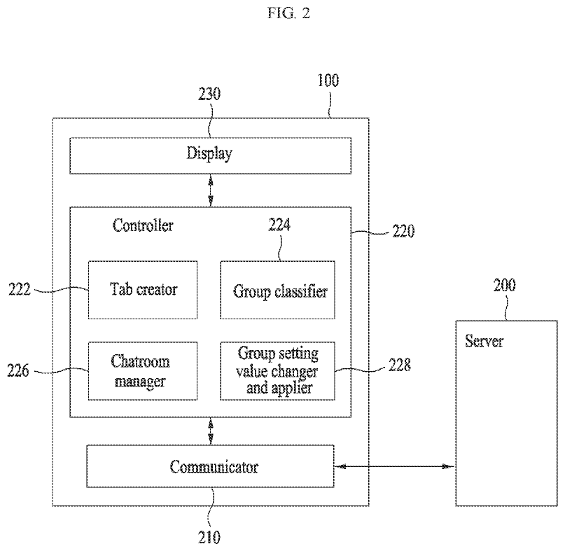

A configuration and an operation of the electronic device 100 that manages a chatroom, a method of classifying chatrooms into a predetermined (or, alternatively, desired) chatroom group, and a method of setting and applying a group setting value are further described with reference to FIGS. 2 to 9.

FIG. 2 illustrates an example of components of an electronic device for managing a chatroom according to at least one example embodiment.

The electronic device 100 of FIG. 2 may correspond to the electronic device 100 of FIG. 1. In the following drawings, although the electronic device 100 is illustrated as a smartphone and a device similar thereto, the electronic device 100 may be, for example, a personal computer (PC), a laptop computer, a tablet, an Internet of things (IoT) device, and a wearable computer.

Referring to FIG. 2, the electronic device 100 may include a communication interface 210, a processor 220, and a display 230. Also, the electronic device 100 may further include an inputter configured to receive an input of a message or an interaction, for example, a drag-and-drop manipulation from a user.

The communication interface 210 may be a device for communication between the electronic device 100 and another electronic device or a server 200. That is, the communication interface 210 may be a hardware module, such as a network interface card, a network interface chip, and a networking interface port, or a software module such as a network device driver or a networking program, of the electronic device 100 configured to send and receive data and/or information about another electronic device or the server 200.

The processor 220 may manage components of the electronic device 100 and may execute a software program or a software application used by the electronic device 100. For example, the processor 220 may be configured to execute the aforementioned messenger application and to process data received from the server 200 or the other electronic device.

Also, the processor 220 may process an operation required to execute the program or the application and process data. The processor 220 may be at least one processor of the electronic device 100 or at least one core in the processor.

The display 230 may include a display device configured to output information or data input from a user, to output messages/contents sent and received through a chatroom, a tab user interface, and a chatroom list, and to output data and/or information provided from the server 200. The display 230 may include a touchscreen. The user of the electronic device 100 may input a message output in a chatroom through a touchscreen or may input an interaction such as an input or a drag-and-drop for managing a chatroom. That is, the display 230 may be configured to include a function of an inputter. The inputter may include a virtual keyboard output on the display 230.

Although not illustrated, the electronic device 100 may include a storage as a device configured to store data or information. The storage may include any memory or storage devices. The storage may store a program or an application executed by the processor 220 and information related thereto. For example, the storage may store messages and/or contents exchanged between users in a chatroom provided through the messenger application. Also, the storage may store information set for each of a plurality of tabs in association with the tab user interface.

The electronic device 100 may request the server 200 to create a chatroom through, for example, the messenger application and may classify the created chatroom into a chatroom group associated with a tab and manage the classified chatroom. The server 200 may be an electronic device configured to provide, for example, a chat service and a content exchange service, associated with the messenger application and may be an electronic device interacting with another server that provides the service.

Hereinafter, a method of managing a chatroom using components 222 to 228 of the processor 220 is described.

The processor 220 may include a tab creator 222 configured to create a tab of the tab user interface 110 associated with a chatroom group to which the chatroom is to belong, a group classifier 224 configured to automatically classify the chatroom into the chatroom group associated with the tab based on a condition according to a chatroom attribute or classify the chatroom into a corresponding chatroom group in response to detecting a drag-and-drop manipulation to the tab for the chatroom, and a chatroom manager 226 configured to display a chatroom list of chatrooms included in the chatroom group in response to receiving a selection on the tab. Also, the processor 220 may include a group setting value changer and applier 228 configured to set a group setting value of the chatroom group associated with the tab for each tab and to apply the set group setting value to a chatroom belonging to the chatroom group.

Each of the components, for example, the tab creator 222, the group classifier, the chatroom manager, and the group setting value changer and applier 228, of the processor 220 may be a software module or a hardware module implemented on the processor 220.

Description related to technical features made above with reference to FIG. 1 may apply to FIG. 2 and thus, further description is omitted.

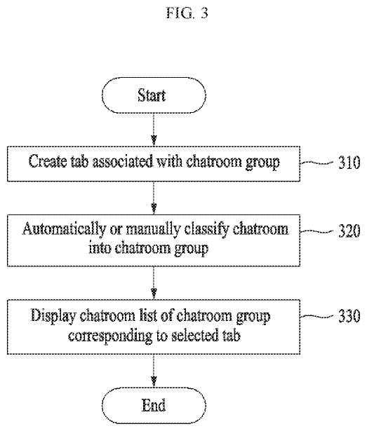

Example embodiments of an operation and a function of the components of the processor 220 and a chatroom management method are further described with reference to FIGS. 3 to 9.

FIG. 3 is a flowchart illustrating an example of a method of managing a chatroom associated with a messenger application using a tab included in a tab user interface according to at least one example embodiment.

Referring to FIG. 3, in operation 310, the tab creator 222 may create a tab of the tab user interface 110 associated with a chatroom group to which a chatroom is to belong. For example, the tab creator 222 may create a new tab in response to detecting a selection on the tab addition user interface 118 from a user.

In operation 320, the group classifier 224 may manually or automatically classify the chatroom into the chatroom group associated with the tab. For example, the group classifier 224 may automatically classify the chatroom into the chatroom group based on a desired condition according to a chatroom attribute (corresponding to an automatic classification). Alternatively or additionally, in response to detecting a drag-and-drop manipulation to the tab for the chatroom, the group classifier 224 may classify the corresponding chatroom into the chatroom group associated with the tab, which corresponds to a manual classification. The automatic classification may be regarded as an automatic classification of the chatroom into the chatroom group in that the chatroom is classified without intervention from the user.

In the automatic classification of the chatroom into the chatroom group associated with the tab, the chatroom attribute may include at least one of chat content included in the chatroom, information associated with a participant of the chatroom, information associated with another chatroom in which the participant of the chatroom participates, and position information associated with the chatroom.

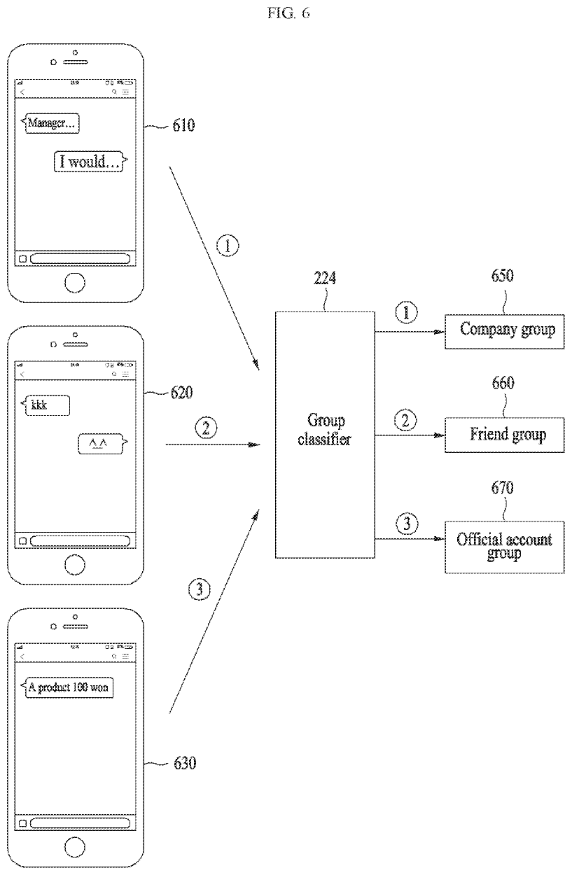

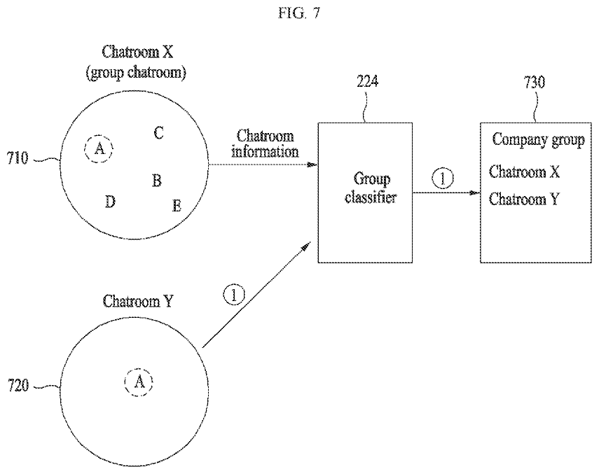

An automatic classification method for automatically classifying a chatroom into a chatroom group associated with a tab is further described with reference to FIGS. 6 and 7.

The manual classification of the chatroom into the chatroom group associated with the tab may be applied to a chatroom that is already automatically or manually classified into a predetermined (or, alternatively, desired) chatroom group to change the chatroom group to which the corresponding chatroom belongs. Alternatively, the manual classification may be applied to a chatroom that is not automatically classified or automatically unclassifiable. That is, a chatroom classified into a specific chatroom group may be reclassified into a chatroom group associated with another tab in response to detecting a drag-and-drop manipulation to the other tab among a plurality of tabs.

For example, by dragging a thumbnail, for example, a chatroom profile, of a chatroom displayed on the display 230 and then dropping the dragged thumbnail on an area on which a desired tab among tabs included in the tab user interface 110 is displayed, the user may classify a chatroom into a chatroom group associated with the tab. Here, a chatroom to which the user moves may be deleted from a chatroom list of a chatroom group from which the user moves and may be added to a chatroom list of a chatroom group to which the user moves.

In operation 330, in response to receiving a selection from the user on the tab, the chatroom manager 226 may display a chatroom list of chatrooms included in the chatroom group through the display 230. For example, in response to a selection on the tab associated with the “Friends” group of FIG. 1, the chatroom manager 226 may display a list of the chatrooms 120 included in the corresponding chatroom group through the display 230.

According to example embodiments, a chatroom may be classified based on a desired condition according to a chatroom attribute or in response to detecting a drag-and-drop manipulation and thus, although a plurality of chatrooms are present in association with the same participant, the plurality of chatrooms may be classified into at least one chatroom group suitable for purpose and intent of each corresponding chatroom, instead of being collectively classified into the same chatroom group.

Description related to technical features made above with reference to FIGS. 1 and 2 may apply to FIG. 3 and thus, further description is omitted.

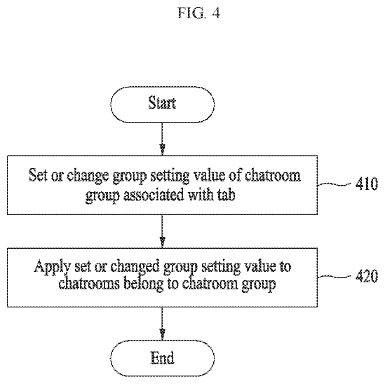

Example embodiments of a chatroom management method are further described with reference to FIGS. 4 to 9.

FIG. 4 is a flowchart illustrating an example of setting a group setting value for a chatroom group including a chatroom for each tab and applying the group setting value to chatrooms belonging to the chatroom group according to at least one example embodiment.

Referring to FIG. 4, in operation 410, the group setting value changer and applier 228 may set or change a group setting value of a chatroom group associated with a tab for each tab.

In operation 420, the group setting value changer and applier 228 may apply the set or changed group setting value to chatrooms belonging to the chatroom group.

The group setting value set or changed for each tab may be a setting value collectively applied to chatrooms belonging to a chatroom group associated with a corresponding tab. The group setting value may include at least one of a notification setting according to reception of a new message, a message processing setting, and a chatroom theme setting. The group setting value set or changed in operation 410 may be preferentially applied to the entire chatrooms corresponding to a setting value of a messenger program, compared to a preset attribute. For example, as one of default attributes of the messenger program, if the notification setting is set as “Notification OFF” and a group setting value of a “Company” group is set as “Notification ON”, a notification is turned ON for chatrooms belonging to the “Company” group. If a new message is received at one of the chatrooms included in the “Company” group, the messenger program may notify reception of the new message by sound or vibration.

The group setting value may be preferentially applied to chatrooms belonging to a chatroom group compared to a preset attribute. However, the group setting value may have a priority over the preset attribute with respect to the entire chatrooms corresponding to a setting value of the messenger program and may not have a priority over a setting value individually set for each chatroom.

Description related to technical features made above with reference to FIGS. 1 to 3 may apply to FIG. 4 and further description related thereto is omitted.

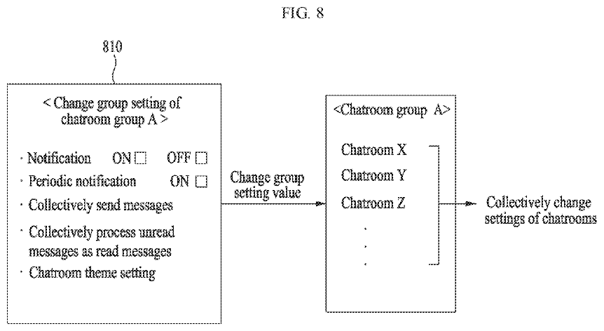

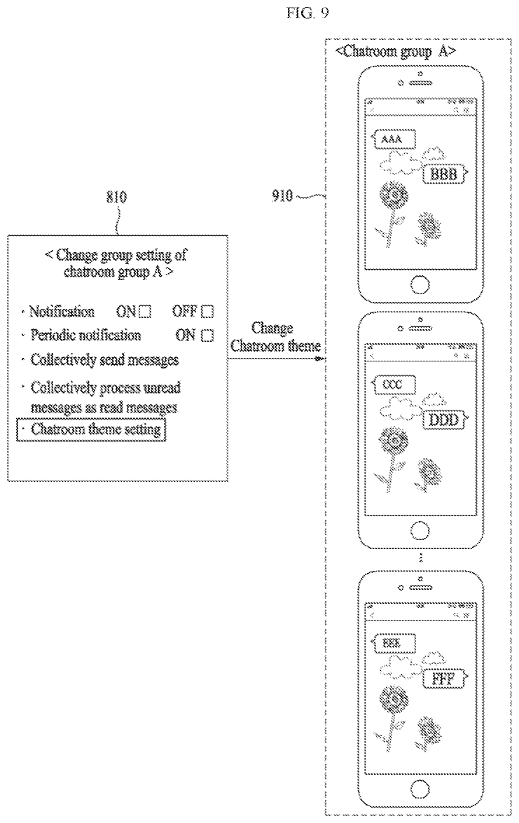

Example embodiments of a group setting value and a method of applying the group setting value to chatrooms are further described with reference to FIGS. 8 and 9.

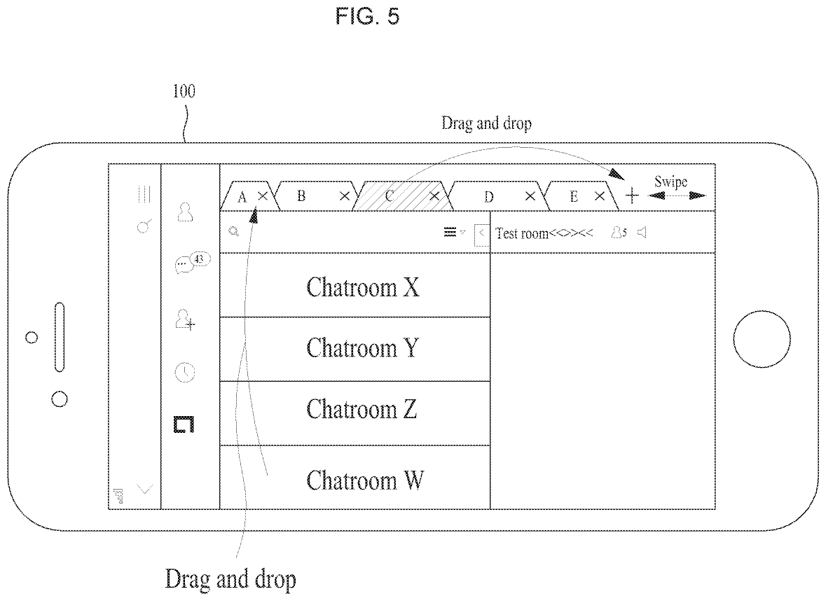

FIG. 5 illustrates an example of a method of classifying a chatroom into a chatroom group associated with a tab and a tab manipulation method according to at least one example embodiment.

A method of classifying a chatroom into a tab associated with a chatroom group or manipulating the tab through interaction of a user with the electronic device 100 is describe with reference to FIG. 5.

Referring to FIG. 5, a tab user interface may include five tabs A, B, C, D, and

Here, the tab C is selected and a chatroom list including chatrooms X, Y, Z, and W belonging to a chatroom group associated with the tab C is displayed.

Referring to FIG. 5, a user may drag the chatroom W and drop the chatroom W at a position corresponding to the tab B such that the group classifier 224 may classify the chatroom W into a chatroom group associated with the tab A. Although not illustrated in FIG. 5, the user may drag a thumbnail, for example, a chatroom profile, corresponding to the chatroom W or a portion in which a text is not displayed, to classify the chatroom W into the chatroom group associated with the tab A.

Also, the chatroom manager 226 may change a position of each tab in response to detecting a drag-and-drop manipulation by the user for each of a plurality of tabs. Referring to FIG. 5, the user may drag the tab C to the right to the tab E such that the chatroom manager 226 may move the tab C to the rightmost.

Meanwhile, the chatroom manager 226 may change a selection of a tab in response to detecting a swipe input from the user on the right of the tab addition user interface 118 for adding a new tab or on an area of a screen of the electronic device 100 on which a text is not displayed. For example, in response to detecting a swipe input in a left/right direction, the chatroom manager 226 may change the selected tab from the tab C to the tab B/tab D. Therefore, a chatroom list of chatrooms belonging to a chatroom group associated with the tab B/tab D may be displayed on the electronic device 100.

Although FIG. 5 illustrates an example in which the electronic device 100 is a mobile user terminal, features of a similar chatroom and/or tab manipulation may apply to an example in which the electronic device 100 is a PC.

Description related to technical features made above with reference to FIGS. 1 to 4 may apply to FIG. 5 and thus, further description is omitted.

Hereinafter, a method of automatically classifying a chatroom into a predetermined (or, alternatively, desired) chatroom group based on a predetermined (or, alternatively, desired) condition according to a chatroom attribute is further described with reference to FIGS. 6 and 7. That is, the method of classifying a chatroom into a chatroom group associated with a tab based on a predetermined (or, alternatively, desired) condition according to a chatroom attribute, described above with FIG. 3, is further described.

An automatic classification of a chatroom into a chatroom group may be automatically performed when the chatroom is created or may be automatically performed when a pre-created chatroom meets a predetermined (or, alternatively, desired) condition, for example, when a message exchange is performed in the pre-created chatroom a predetermined (or, alternatively, desired) number of times or more.

The group classifier 224 may classify a chatroom that meets the same condition into the same chatroom group. That is, the group classifier 224 may automatically classifying still another chatroom corresponding to the same condition into the chatroom group.

FIG. 6 illustrates an example of a method of automatically classifying a chatroom into a predetermined (or, alternatively, desired) chatroom group based on chat content included in the chatroom according to at least one example embodiment.

A chatroom attribute may include chat content included in a chatroom. That is, the group classifier 224 may classify a corresponding chatroom into a predetermined (or, alternatively, desired) chatroom group based on a result of analyzing, for example, parsing chat content, for example, texts, symbols, and images, included in messages in the chatroom.

The predetermined (or, alternatively, desired) condition for the chatroom attribute may include at least one of whether a preset word is used in the chatroom a predetermined (or, alternatively, desired) number of times or at a predetermined (or, alternatively, desired) ratio or more, whether a formal expression or an informal expression is used in the chatroom the number of times or at the ratio or more, and whether an emoticon or a sticker is used in the chatroom the number of times or at the frequency or ratio or more.

1) The predetermined (or, alternatively, desired) condition according to the chatroom attribute may represent whether the preset word is included in the chatroom the predetermined (or, alternatively, desired) number of times or at the predetermined (or, alternatively, desired) ratio or more. For example, the group classifier 224 may classify, into a “company” group, a chatroom in which a word (e.g., a president, a manager, a deputy manager, a deputy, etc.) representing a job position or a job title occurs the predetermined (or, alternatively, desired) number of times or at the predetermined (or, alternatively, desired) ratio or more. Referring to FIG. 6, a chatroom 610 that includes a word “manager” may be classified into a company group 650. Alternatively, the group classifier 224 may classify a chatroom in which a word (e.g., mom and dad) related to a family occurs the predetermined (or, alternatively, desired) number of times or at the predetermined (or, alternatively, desired) ratio or more, into a “family” chatroom group. Here, the preset word may be set by a user or may be preset by a messenger application. For example, the user may set a word frequently used in a company or work of the user as a word associated with the company group 650. The “ratio” may represent a ratio of a number of appearances of a corresponding word to a number of messages included in the chatroom.

2) The predetermined (or, alternatively, desired) condition according to the chatroom attribute may represent whether a formal expression (e.g., honorifics) or an informal expression is included in the chatroom the predetermined (or, alternatively, desired) number of times or at the predetermined (or, alternatively, desired) ratio or more. For example, the group classifier 224 may classify, into the “company” group, a chatroom in which a formal expression such as “I would˜” is included the predetermined (or, alternatively, desired) number of times/at the predetermined (or, alternatively, desired) ratio or more. Referring to FIG. 6, the chatroom 610 that includes an expression “I would˜” may be classified into the company group 650. Alternatively, the group classifier 224 may classify, into a “friend” group, a chatroom in which an expression corresponding to an informal expression, such as, for example, “do˜” and “did you˜?”, is included the predetermined (or, alternatively, desired) number of times/at the predetermined (or, alternatively, desired) ratio or more. Words or expressions corresponding to the formal expression and the informal expression may be set by the user or may be preset by the messenger application. The “ratio” may represent a ratio of a number of appearances of a corresponding formal expression/informal expression to a number of messages included in the chatroom.

3) The predetermined (or, alternatively, desired) condition according to the chatroom attribute may represent whether an emoticon or a sticker is included in the chatroom the predetermined (or, alternatively, desired) number of times or at the predetermined (or, alternatively, desired) frequency or more. For example, the group classifier 224 may classify, into the “friend” group, an expression corresponding to the emoticon, the sticker, or emoji is included the predetermined (or, alternatively, desired) number of times or at the predetermined (or, alternatively, desired) ratio or more. Referring to FIG. 6, a chatroom 620 that includes an expression, such as, for example, “kkk” and “\hat{ }_\hat{ }”, may be classified into a friend group 660. Such an emoticon, a sticker, and emoji may be provided as default values from the messenger application or may be additionally downloaded by the electronic device 100. The “ratio” may represent a ratio of a number of appearances of emoji/sticker/emoticon to a number of messages included in the chatroom.

4) The predetermined (or, alternatively, desired) condition according to the chatroom attribute may represent whether content corresponding to an advertisement is included in the chatroom. For example, the group classifier 224 may classify, into an “official account” group, a chatroom in which an expression, such as, for example, a price of a product and an “[advertisement]” is included as the expression corresponding to the advertisement. Referring to FIG. 6, a chatroom 630 that includes an expression representing price of a product may be classified into an official account group 670.

FIG. 7 illustrates an example of a method of automatically classifying a chatroom into a predetermined (or, alternatively, desired) chatroom group based on information associated with another chatroom in which a participant of the chatroom participates according to at least one example embodiment.

A chatroom attribute may include information associated with another chatroom in which a participant participates.

The other chatroom may be, for example, a group chatroom for chat among at least three participants. The group classifier 224 may classify, into the same chatroom group, individual chatrooms for chatting with the respective participants that participate in the group chatroom.

FIG. 7 illustrates an example of classifying a chatroom Y 720 for the user of the electronic device 100 to chat with a user A into a predetermined (or, alternatively, desired) chatroom group. The user A is a participant of the chatroom Y 720 and is also a participant of a chatroom X 710 that is a group chatroom. The chatroom X 710 may be a chatroom in which the user of the electronic device 100 also participates. That is, the chatroom X 710 may be a group chatroom in which the user of the electronic device 100 participate to chat with users A, B, C, D, and E. In FIG. 7, displaying the user of the electronic device 100 as the participant in the chatroom X 710 and the chatroom Y 720 is omitted.

The group classifier 224 may classify the chatroom Y 720 into the same chatroom group as that of the chatroom X 710 based on chatroom information of the chatroom X 710, for example, information describing that the user A is participating in the chatroom X 710. For example, when the chatroom X 710 corresponds to a “company” group including company members, the chatroom Y 720 may be classified into a company group 730. When the chatroom X 710 corresponds to a “family” group including family members, the chatroom Y 720 may be classified into the “family” group. Alternatively, if a conversation topic of the chatroom X 710 is related to company work such as a company project, the chatroom Y 720 may be classified into the company group 730. If the conversation topic of the chatroom X 710 is related to a family travel, the chatroom Y 720 may be classified into the “family” group. The conversation topic of the group chatroom may be set by a user that requests creation of the group chatroom or may be input from the user when creating the group chatroom. Alternatively, the conversation topic of the group chatroom may be set by one of participants participating in the group chatroom after the group chatroom is created. Alternatively, if a predetermined (or, alternatively, desired) period of time elapses after the group chatroom is created, the conversation topic of the group chatroom may be automatically determined by analyzing the conversation made through the group chatroom. The group classifier 224 may identify the conversation topic set to the group chatroom and may use the identified conversation topic to classify the chatroom into the chatroom group.

The group classifier 224 may classify the chatroom Y 720 into a predetermined (or, alternatively, desired) chatroom group based on information of the chatroom X 710 that is the group chatroom. For example, the group classifier 224 may classify the chatroom X 710 that is the group chatroom and the chatroom Y 720 into the same chatroom group.

Also, the group classifier 224 may classify, in the same chatroom group, chatrooms for the user of the electronic device 100 to chat with the respective other users B, C, D, and E that participate in the chatroom X 710. For example, an individual chatroom for the user of the electronic device 100 to chat with the participant B and an individual chatroom for the user of the electronic device 100 to chat with the participant C may be classified into the same chatroom group. Here, the individual chatrooms may be classified into the company group 730 that is the same group as that is the chatroom X 710.

A name of the classified chatroom group may be determined based on a name of the chatroom X 710 that is the group chatroom or a conversation topic of the chatroom X 710. For example, the name of the chatroom group to which the chatroom X 710 or the chatroom Y 720 belongs may be determined as “company” based on the name, “company,” of the group chatroom of the chatroom X 710 or may be determined as “company” based on “company work” that is the conversation topic of the chatroom X 710.

As another example, the chatroom attribute may include information associated with a participant of the chatroom. The participant may not be the user of the electronic device 100 but a chat partner of the chatroom. Here, a predetermined (or, alternatively, desired) condition may be set based on at least one of profile information (profile information created by the corresponding participant or profile information created by the user of the electronic device 100) set for the participant of the chatroom, position information of the participant, and contact information associated with the participant that is stored in a user terminal, for example, the electronic device 100, associated with the messenger application.

For example, the group classifier 224 may analyze affiliation information (e.g., XX corporation and AA university) included in profile information set for the participant of the chatroom and may classify the chatroom into a chatroom group, such as, for example, a company group or a friend group. Also, the group classifier 224 may analyze affiliation information (e.g., XX corporation and AA university) or relationship information (family, friends, and colleagues) represented by information included in contact information associated with the participant stored in the electronic device 100 and may classify the chatroom into the chatroom group, such as, for example, the company group and the friend group. Also, the group classifier 224 may classify the chatroom into a “near position” group, a “distant position” group, or a chatroom group that represents a specific regional name associated with position information, based on position information of the participant.

Also, when the chatroom is related to an official account of an organization or is created to chat with a chatbot of the official account, the group classifier 224 may classify the chatroom into an official account group.

As another example, the chatroom attribute may include position information associated with the chatroom. Here, a predetermined (or, alternatively, desired) condition may be set based on position information set when creating the chatroom or position information of a participant that creates the chatroom when creating the chatroom. For example, when creating the chatroom, the group classifier 224 may classify the chatroom into a position group associated with position information set by the user of the electronic device 100. Alternatively, the group classifier 224 may classify the chatroom into a position group associated with position information set by the user of the electronic device 100 or the participant of the chatroom for the chatroom. Alternatively, the group classifier 224 may classify the chatroom into a position group associated with position information of a participant that creates the chatroom when creating the chatroom. The participant that creates the chatroom may be the user of the electronic device 100 or a chat partner in the chatroom.

According to example embodiments, a chatroom classification may be automatically implemented in such a manner that a chatroom associated with a messenger application may be automatically classified into a chatroom group associated with a tab based on a condition according to an attribute of the corresponding chatroom.

Description related to technical features made above with reference to FIGS. 1 to 5 may apply to FIGS. 6 and 7 and thus, further description is omitted.

FIG. 8 illustrates an example of a method of setting a group setting value for a chatroom group associated with a tab and collectively applying the set group setting value to chatrooms belonging to the chatroom group according to at least one example embodiment.

As described above with reference to FIG. 4, a group setting value may include at least one of a notification setting according to reception of a new message, a message processing setting, and a chatroom theme setting, as a setting value collectively applied to chatrooms belonging to a chatroom group.

The group setting value may be an attribute of a chatroom that is preferentially applied to the chatrooms belonging to the chatroom group compared to a preset attribute with respect to the entire chatrooms corresponding to a setting value of a messenger program.

FIG. 8 illustrates an example of a setting screen 810 of a group setting value for a chatroom group A according to at least one example embodiment.

Referring to FIG. 8, the group setting value may include a notification setting and the notification setting may include turning off or on a notification function according to reception of a new message.

Also, the notification setting may be to turn ON/OFF a setting of outputting a notification at a desired time interval in response to receiving the new message. The desired time interval may be set by the user of the electronic device 100.

Therefore, the group setting value changer and applier 228 may send a periodic notification in response to a selection from the user, for example, in response to a new message received in chatrooms belonging to a company group requiring urgent verification and may not send a notification for a new message received in chatrooms belonging to a friend group in which new messages are frequently received.

In a chatroom belonging to a chatroom group, the notification setting corresponding to the group setting value may have a priority over a notification setting set for the entire messenger program. That is, regardless of a notification setting corresponding to a setting value of the messenger program, a notification for the corresponding chatroom may be controlled based on the notification setting corresponding to the group setting value.

Also, referring to FIG. 8, the group setting value may include the message processing setting. The message processing setting may include collectively sending messages to chatrooms belonging to a chatroom group or collectively processing unread messages received at the chatrooms belonging to the chatroom group as read messages. Based on a selection from the user, the group setting value changer and applier 228 may collectively send the same message to the chatrooms belonging to the chatroom group and may collectively process unread messages in chatrooms belonging to the chatroom group as read messages.

Also, referring to FIG. 8, the group setting value may include the chatroom theme setting. The chatroom theme setting may include changing at least one of a theme setting, a background screen setting, and a background music setting for all of the chatrooms belonging to the chatroom group, a profile setting of a participant associated with a corresponding chatroom belonging to the chatroom group, and a profile setting of the chatroom belonging to the chatroom group

For example, the group setting value changer and applier 228 may change a theme of a corresponding chatroom with a theme that is set based on a setting of the group setting value, instead of using a theme preset for the chatroom belonging to the chatroom group.

The group setting value changer and applier 228 may change at least one of a color, a pattern, a brightness, and a transparence of a background screen of a corresponding chatroom belonging to the chatroom group, based on the setting of the group setting value. Also, the group setting value changer and applier 228 may change a background music setting of a corresponding chatroom belonging to the chatroom group based on the setting of the group setting value. For example, down or gloomy background music may be set for a company group and bright and active background music may be set for a friend group. Also, the group setting value changer and applier 228 may change a profile setting of a participant associated with a corresponding chatroom belonging to the chatroom group based on the setting of the group setting value. For example, information about the chatroom group, for example, a name of the chatroom group, may be added to profiles of participants of the chatroom belonging to the chatroom group. Such change in the profile setting may relate to a change only in the chatroom group associated with the tab. Here, the change in the profile setting may be implemented by changing the profile setting with respect to the entire messenger program. Also, the group setting value changer and applier 228 may change a profile setting of a corresponding chatroom belonging to the chatroom group based on the setting of the group setting value. For example, information about the chatroom group, for example, the name of the chatroom group, may be added to profiles of chatrooms belonging to the chatroom group.

An example of changing a chatroom theme setting in a chatroom within a chatroom group in response to a change in a group setting value is further described with reference to FIG. 9.

Description related to technical features made above with reference to FIGS. 1 to 7 may apply to FIG. 8 and thus, further description is omitted.

FIG. 9 illustrates an example of a method of changing a chatroom theme setting using a group setting value according to at least one example embodiment.

The group setting value changer and applier 228 may change a theme of a corresponding chatroom with a theme that is set based on a setting of the group setting value, instead of using a theme preset for the corresponding chatroom belonging to a chatroom group. FIG. 9 illustrates an example in which a background screen for chatrooms 910 belonging to a chatroom group A is changed in response to a selection on a chatroom theme change according to a change in a group setting value for the chatroom group A.

Referring to FIG. 9, a background screen according to a change in the group setting value may be displayed for the chatrooms 910 belonging to the chatroom group A, instead of displaying a background screen preset for each of the chatrooms 910.

Also, although not illustrated, the group setting value changer and applier 228 may change at least one of a font, a color, and a transparency of a message based on the change in the group setting value.

Therefore, a theme or a background screen suitable for a chatroom group may be collectively applied to chatrooms belonging to the chatroom group.

Description related to technical features made above with reference to FIGS. 1 to 8 may apply to FIG. 9 and thus, further description is omitted.

In the example embodiments, an operation performed by the electronic device 100 and the components thereof may be performed by the server 200 or another server. For example, a configuration of classifying a chatroom into a chatroom group may be performed on a server side. That is, at least a portion of operations performed by the electronic device 100 that is a client may be performed on the server side. On the contrary, at least a portion of operations performed on the server side may be performed by the electronic device 100 corresponding to the client.

The systems or the apparatuses described herein may be implemented using hardware components, software components, and/or a combination thereof. For example, the described apparatuses and components may be implemented using one or more general-purpose or special purpose computers, such as, for example, a processor, a controller, an arithmetic logic unit (ALU), a digital signal processor, a microcomputer, a field programmable array (FPA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of the processing device is used as singular; however, one skilled in the art will appreciate that the processing device may include multiple processing elements and multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, virtual equipment, computer record medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable record mediums.

The methods according to the above-described example embodiments may be configured in a form of program instructions performed through various computer devices and recorded in non-transitory computer-readable media. The media may also include, alone or in combination with the program instructions, data files, data structures, and the like. The media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of program instructions include both machine code produced by a compiler and higher level program code that is executed using an interpreter. The hardware devices may be configured to operate as at least one software module to perform operations of example embodiments or vice versa.

The foregoing embodiments are merely examples and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method of displaying a first chatroom through a tab user interface of a messenger application executed by a user terminal, the method comprising:
creating a first tab associated with a first chatroom group in response to an input from a first user of the user terminal;
automatically classifying the first chatroom into the first chatroom group based on a chatroom attribute or classifying the first chatroom into the first chatroom group in response to detecting a first drag-and-drop manipulation of dragging the first chatroom to the first tab and then dropping the first chatroom into the first tab; and
displaying a chatroom list of a plurality of chatrooms that belong to the first chatroom group in response to a selection of the first tab.

2. The method of claim 1, wherein the chatroom attribute comprises at least one of chat content included in the first chatroom, information associated with a participant of the first chatroom, information associated with a second chatroom in which the participant of the first chatroom participates, and position information associated with the first chatroom.

3. The method of claim 2, wherein the chatroom attribute comprises the chat content included in the first chatroom, and
the automatically classifying the first chatroom comprises: automatically classifying the first chatroom into the first chatroom group based on a first condition, a second condition, or a third condition,
wherein the first condition is satisfied when a preset word occurs a first preset number of times or more in the first chatroom, or occurs at or higher than a first preset ratio corresponding to a number of occurrences of the preset word to a number of messages in the first chatroom,
wherein the second condition is satisfied when a formal expression or an informal expression occurs a second preset number of times or more in the first chatroom, or occurs at or higher than a second preset ratio corresponding to a number of occurrences of the formal expression or the informal expression to the number of messages in the first chatroom, and
wherein the third condition is satisfied when an emoticon or a sticker occurs a third preset number of times or more in the first chatroom, or occurs at or higher than a third preset ratio corresponding to a number of occurrences of the emoticon or the sticker in the first chatroom, and
wherein the method further comprises: classifying the second chatroom which satisfies a same condition as the first chatroom into the first chatroom group, among the first condition, the second condition, and the third condition.

4. The method of claim 2, wherein the chatroom attribute comprises the information associated with the participant of the first chatroom,
wherein the automatically classifying the first chatroom comprises: automatically classifying the first chatroom into the first chatroom group according to a condition that is set based on at least one of profile information of the participant, position information of the participant, and contact information associated with the participant that is stored in the user terminal, and
wherein the method further comprises automatically classifying the second chatroom, which satisfies the same condition as the first chatroom, into the first chatroom group.

5. The method of claim 2, wherein the chatroom attribute comprises the information associated with the second chatroom in which the participant of the first chatroom participates,
the first chatroom is a personal chatroom for two participants comprising the first user and a second user and the second chatroom is a group chatroom for at least three participants comprising the first user and the second user, and
the automatically classifying the first chatroom comprises automatically classifying the first chatroom into the first chatroom group into which the group chatroom is classified in response to the group chatroom being classified in advance, or automatically classifying the first chatroom into a second chatroom group related to an identified conversation topic of the group chatroom.

6. The method of claim 5, wherein a name of the first chatroom group is determined based on a name of the group chatroom or the identified conversation topic of the group chatroom.

7. The method of claim 2, wherein the chatroom attribute comprises the position information associated with the first chatroom,
wherein the automatically classifying the first chatroom comprises: automatically classifying the first chatroom into the first chatroom group according to a condition that is set based on a first position of the user terminal at a time of creating the first chatroom or a second position of the first user that creates the first chatroom at the time of creating the first chatroom, and
wherein the method further comprises automatically classifying the second chatroom, which satisfies the same condition as the first chatroom, into the first chatroom group.

8. The method of claim 1, wherein the tab user interface comprises a plurality of tabs, and
wherein the method further comprises reclassifying the first chatroom into a second chatroom group associated with a second tab in response to detecting a second drag-and-drop manipulation of dragging the first chatroom to the second tab, among the plurality of tabs.

9. The method of claim 1, further comprising:
setting a group setting value of the first chatroom group associated with the first tab; and
applying the group setting value to the plurality of chatrooms belonging to the first chatroom group.

10. The method of claim 9, wherein the group setting value comprises at least one of a notification setting according to reception of a new message, a message processing setting, and a chatroom theme setting, as the group setting value that is collectively applied to the plurality of chatrooms belonging to the first chatroom group.

11. The method of claim 10, wherein the group setting value comprises the notification setting, to turn off or on a notification according to the reception of the new message or to output the notification at a preset time interval in response to receiving the new message.

12. The method of claim 10, wherein the group setting value comprises the message processing setting, and
the message processing setting comprises collectively sending messages to the plurality of chatrooms belonging to the first chatroom group or collectively processing unread messages received at the plurality of chatrooms belonging to the first chatroom group as read messages.

13. The method of claim 10, wherein the group setting value comprises the chatroom theme setting, and
the chatroom theme setting comprises changing at least one of a background screen setting for all chatrooms belonging to the first chatroom group, a background music setting for all the chatrooms belonging to the first chatroom group, a profile setting of a participant associated with the first chatroom belonging to the first chatroom group, and a profile setting of the first chatroom belonging to the first chatroom group.

14. The method of claim 1, wherein the tab user interface comprises a user interface of adding a second tab or deleting the first tab, and
the first tab displays a name of the first tab, a number of chatrooms in which a new message is received among the plurality of chatrooms in the first chatroom group associated with the first tab, or a number of new messages in the plurality of chatrooms in the first chatroom group associated with the first tab.

15. The method of claim 1, wherein the tab user interface comprises a plurality of tabs, and
positions of the plurality of tabs vary based on a third drag-and-drop manipulation on the plurality of tabs.

16. A non-transitory computer-readable record medium storing instructions that, when executed by a processor, cause the processor to perform the method of claim 1.

17. An electronic device for displaying a chatroom through a tab user interface of a messenger application, the electronic device comprising:
at least one memory configured to store one or more instructions; and
at least one processor configured to execute the one or more instructions to:
create a tab associated with a chatroom group in response to an input from a user of the electronic device;
automatically classify the chatroom into the chatroom group based on a chatroom attribute or classify the chatroom into the chatroom group in response to detecting a drag-and-drop manipulation of dragging the chatroom to the for the chatroom and then dropping the chatroom into the tab; and
display a chatroom list of a plurality of chatrooms that belong to the chatroom group in response to receiving a selection of the tab.

18. The electronic device of claim 17, wherein the least one processor is further configured to execute the one or more instructions to:
set a group setting value of the chatroom group associated with the tab and apply the group setting value to the plurality of chatrooms belonging to the chatroom group.

19. An electronic device for executing a messenger application, the electronic device comprising:
a display;
at least one memory configured to store one or more instructions; and
at least one processor configured to execute the one or more instructions to:
control the display to display, on the messenger application, a plurality of tabs corresponding to a plurality of different chatroom groups, respectively;
automatically classify a first chatroom including a new message into a first chatroom group based on an attribute of the new message, among the plurality of different chatroom groups; and
automatically place the first chatroom including the new message in a first tab corresponding to the first chatroom group, among the plurality of tabs on the messenger application.

20. The electronic device of claim 19, wherein the attribute of the new message comprises occurrence of a preset word in the new message.
